(19) United States
(12) Patent Application Publication
(10) Pub. No.: US 2021/0344588 A1
(43) Pub. Date: Nov. 4, 2021

(54) ROUTING PATH CALCULATION METHOD, SYSTEM AND DEVICE, AND COMPUTER-READABLE STORAGE MEDIUM

(71) Applicant: ZTE CORPORATION, Shenzhen (CN)

(72) Inventor: Peng ZHU, Shenzhen (CN)

(21) Appl. No.: 17/281,109

(22) PCT Filed: Sep. 23, 2019
(86) PCT No.: PCT/CN2019/107367

§ 371 Date: Mar. 29, 2021

(30) Foreign Application Priority Data
Sep. 29, 2018 (CN) 201811152235.7

(51) Int. Cl. H04L 12/721; H04L 12/751; H04L 12/717

(52) U.S. Cl. CPC H04L 45/12; H04L 45/42; H04L 45/02; H04L 45/14

(57) ABSTRACT

A routing path calculation method, system and device, and a computer-readable storage medium are provided. The number n of passing constraint condition or conditions is determined, and n network topology layer or layers are correspondingly copied. Different layer attribute information is configured for an original network topology layer and the n copied network topology layer or layers. Connection of at least one link of each network topology layer is modified according to the n passing constraint condition or conditions, and connection of at least one one-way link is established between two network topology layers with adjacent layer attribute information. A k-optimal path from a starting point of a head network topology layer to an ending point of an end network topology layer is calculated by a k-optimal path algorithm. The layer attribute information of at least one node in the k-optimal path is restored to obtain a final path.

### CROSS-REFERENCE TO RELATED APPLICATION

The present application claims priority to Chinese Patent Application No. 201811152235.7, filed before the China National Intellectual Property Administration on Sep. 29, 2018 and entitled “Routing Path Calculation Method, System and Device, and Computer-Readable Storage Medium”, the entire contents of which are incorporated herein by reference.

### TECHNICAL FIELD

The present disclosure relates to the technical field of communication, and particularly to a routing path calculation method, system and device, and a computer-readable storage medium.

### BACKGROUND

With the constant development of an Automatically Switched Optical Network (ASON) technology and a Software Defined Network (SDN), more and more service providers have started adopting optical network devices for networking, and have implemented automatic path calculation and connection establishment for calls in a control layer to realize planning and calculation functions for entire call paths.

In path calculation, a K-optimal path may usually be provided for wavelength allocation to increase the probability that wavelength allocation succeeds. At present, most K-optimal path algorithms are implemented based on a dijsktra algorithm. When an input condition of a K-optimal path algorithm is that multiple links and nodes are required to be passed, a piecewise path calculation method is usually adopted, and then paths that are calculated piecewise are spliced into complete K paths. In the piecewise path calculation algorithm, when the piecewise paths are spliced, it is usually necessary to select a certain sequence of the nodes and links required to be passed, then piecewise K-optimal path calculation is performed according to the sequence, and finally, the piecewise paths are spliced one by one. Such a piecewise path calculation method has the following defects.

1) Since the K-optimal path algorithm requires an extremely large calculation count, when there is no constraints for the sequence of the nodes and links required to be passed, the calculation count is also required to be multiplied by (n-1)!, which makes it impossible to complete the path calculation in reasonable time.

2) Since a total cost value for the finally spliced path is related to a calculation sequence of K-optimal paths, when there is no constraint for the sequence of the nodes and links required to be passed, it cannot be ensured that an optimal low-cost path is always calculated at first.

3) For non-directional links required to be passed, special processing is required, for example, continuous links required to be passed are bundled into one node, to ensure that a non-directional path required to be passed can be calculated correctly. However, the algorithm is quite complicated and difficult to design and maintain.

4) In some cases, only one condition in a set of nodes or links is required to be passed, namely one of multiple constraints is required to be passed. However, the present piecewise path calculation algorithm cannot meet this requirement.

### SUMMARY

In view of the above defects, the embodiments of the present disclosure provide a routing path calculation method, system and device, and a computer-readable storage medium, which may solve at least one of the problems that optimal k-optimal path calculation under the condition of no sequence between passing constraints cannot be implemented through an existing piecewise path calculation algorithm in reasonable time, that special processing is required for non-directional links required to be passed to make the algorithm complicated and difficult to design and maintain, and that path calculation under a constrained type that only one of multiple constraints is required to be met cannot be implemented.

The following technical solutions are adopted in the present disclosure to solve the technical problems.

According to an aspect of the embodiments of the present disclosure, a routing path calculation method is provided, which may include the following operations. The number n of passing constraint condition or conditions is determined, and n network topology layer or layers are correspondingly copied, wherein n is a positive integer. Different layer attribute information is configured for an original network topology layer and the n copied network topology layer or layers. Connection of at least one link of each network topology layer is modified according to the n passing constraint condition or conditions, and connection of at least one one-way link is established between two network topology layers with adjacent layer attribute information. A k-optimal path from a starting point of a head network topology layer to an ending point of an end network topology layer is calculated by use of a k-optimal path algorithm. Restoration processing is performed on the layer attribute information of at least one node in the k-optimal path to obtain a final path.

According to another aspect of the embodiments of the present disclosure, a routing path calculation system is provided, which may include: a topology layer copying unit, configured to determine the number n of passing constraint condition or conditions and correspondingly copy n network topology layer or layers, wherein n is a positive integer; a layer attribute setting unit, configured to configure different layer attribute information for an original network topology layer and the n copied network topology layer or layers; a link topology modification unit, configured to modify connection of at least one link of each network topology layer according to the n passing constraint condition or conditions and establish connection of at least one one-way link between two network topology layers with adjacent layer attribute information; a k-optimal path calculation unit, configured to calculate a k-optimal path between a starting point of a head network topology layer to an ending point of an end network topology layer by use of a k-optimal path algorithm; and a layer attribute restoration unit, configured to perform restoration processing on the layer attribute information of at least one node in the k-optimal path to obtain a final path.

According to another aspect of the embodiments of the present disclosure, a routing path calculation device is provided, which may include a memory, a processor and a computer program stored in the memory and capable of running in the processor, wherein the computer program may be executed by the processor to implement the operations of the routing path calculation method.

According to another aspect of the embodiments of the present disclosure, a computer-readable storage medium is provided, in which a computer program may be stored, wherein the computer program may be executed by a processor to execute the operations of the routing path calculation method.

### BRIEF DESCRIPTION OF THE DRAWINGS

In order to describe the technical solutions in the embodiments of the present disclosure more clearly, the drawings referred to when describing the embodiments or a related art will be simply introduced below. It is apparent that the drawings described below are related to only some embodiments of the present disclosure. Those of ordinary skill in the art may further obtain other drawings according to these drawings without creative work.

FIG. 1 is an implementation flowchart of a routing path calculation method according to embodiment 1 of the present disclosure;

FIG. 2 is a topological diagram of an original network topology layer according to a preferred implementation example of the present disclosure;

FIG. 3 is a schematic diagram of modifying a network topology under a single-node constraint according to a preferred implementation example of the present disclosure;

FIG. 4 is a schematic diagram of modifying a network topology under a single-link constraint according to a preferred implementation example of the present disclosure;

FIG. 5 is a schematic diagram of modifying a network topology under an “or”-type constraint in which only one of multiple conditions needs to be met according to a preferred implementation example of the present disclosure;

FIG. 6 is a schematic diagram of modifying a network topology under an “and”-type constraint in which multiple conditions need to be simultaneously met according to a preferred implementation example of the present disclosure;

FIG. 7 is an example diagram of a path calculation result obtained under multiple condition constraints according to a preferred implementation example of the present disclosure;

FIG. 8 is an implementation flowchart of a routing path calculation method according to embodiment 2 of the present disclosure;

FIG. 9 is a structure diagram of a routing path calculation system according to embodiment 3 of the present disclosure; and

FIG. 10 is a structure diagram of a routing path calculation device according to embodiment 4 of the present disclosure.

### DETAILED DESCRIPTION OF THE EMBODIMENTS

For making the technical problems to be solved, the technical solutions and beneficial effects in the present disclosure clearer, the present disclosure will further be described below in combination with the drawings and embodiments in detail. It should be understood that the specific embodiments described herein are adopted not to limit the present disclosure but only to explain the present disclosure.

### Embodiment 1

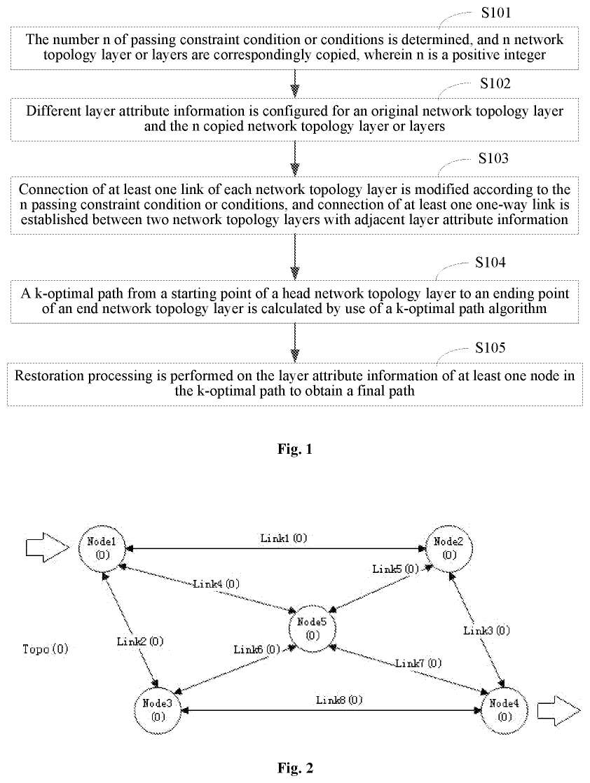

FIG. 1 is an implementation flowchart of a routing path calculation method according to embodiment 1 of the present disclosure. An execution subject of the method is a routing path calculation system/device in the embodiments of the present disclosure. As shown in FIG. 1, the routing path calculation method provided in the embodiment may include the following operations.

In S101, the number n of passing constraint condition or conditions is determined, and n network topology layer or layers are correspondingly copied, wherein n is a positive integer.

There may be one or multiple passing constraint conditions of a routing path, wherein multiple refers to two or more than two. Correspondingly copying the n network topology layer or layers refers to correspondingly copying the n network topology layer or layers according to the original network topology layer of a routing device.

In S102, different layer attribute information is configured for an original network topology layer and the n copied network topology layer or layers.

Configuring the different layer attribute information for each network topology layer refers to assigning different layer numbers to the network topology layers. For example, in a specific implementation example, the original network topology layer is numbered to be 0, the first copied network topology layer is numbered to be 1, the second copied network topology layer is numbered to be 2, and by parity of reasoning, the nth copied network topology layer is numbered to be n. Correspondingly, “n” is also marked after each node Identifier (ID) and each link ID in each network topology layer to represent that they belong to the nth network topology layer.

In S103, connection of at least one link of each network topology layer is modified according to the n passing constraint condition or conditions, and connection of at least one one-way link is established between two network topology layers with adjacent layer attribute information.

In an exemplary implementation of the embodiment, when the n passing constraint condition or conditions indicate that one node is required to be passed, n is equal to 1, and one network topology layer is correspondingly copied. The operation S103 may be implemented in the following manner. The connection of a one-way link between the node required to be passed in the original network topology layer and the node required to be passed in the copied network topology layer is established, and cost of the one-way link is set to be 0.

For example, if a network topology of the original network topology layer is shown in FIG. 2 and the passing constraint condition indicates that Node5 is required to be passed, a copy, recorded as a network topology layer Topo(1), of the original network topology layer Topo(0) is made, and all nodes and links in the network topology layer Topo(1) have a layer attribute “1”.

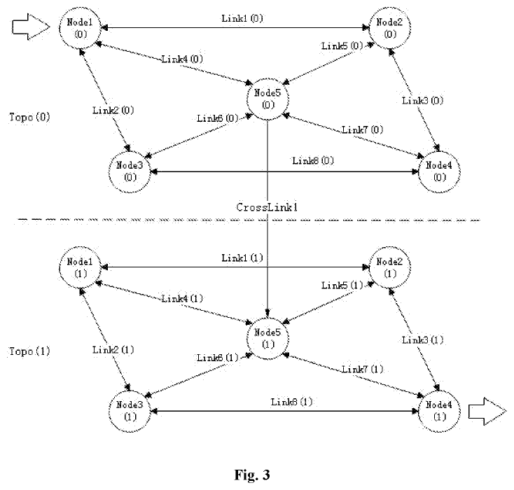

Node5(0) (i.e., Node5 in the layer Topo(0)) is connected with Node5(1) (i.e., Node5 in the layer Topo(1)) through a one-way link CrossLink1, and cost of the one-way link is set to be 0. In such a manner, a modified network topology can be obtained, specifically as shown in FIG. 3.

Subsequently, in S104, K-optimal path calculation is performed by taking Node1(0) as a head node and taking Node4(1) as an end node to obtain all K-optimal paths required to pass Node5.

Finally, in S105, node IDs with a layer attribute “1” in a path calculation result are restored, and the nodes Node5(0) and Node5(1) are combined to obtain a final path.

In an exemplary implementation of the embodiment, when the n passing constraint condition or conditions indicate that one link required to be passed is required to be passed, n is equal to 1, and one network topology layer is correspondingly copied. The operation S103 may be implemented in the following manner. Connection of a one-way link between a first node of the link required to be passed in the original network topology layer and a second node of the link required to be passed in the copied network topology layer is established, and cost of the one-way link is set to be cost of a link in a direction from the first node to the second node in the same network topology layer. Connection of a one-way link between a second node of the link required to be passed in the original network topology layer and a first node of the link required to be passed in the copied network topology layer is established, and cost of the one-way link is set to be cost of a link in a direction from the second node to the first node in the same network topology layer. The link required to be passed in the original network topology layer and the link required to be passed in the copied network topology layer are deleted.

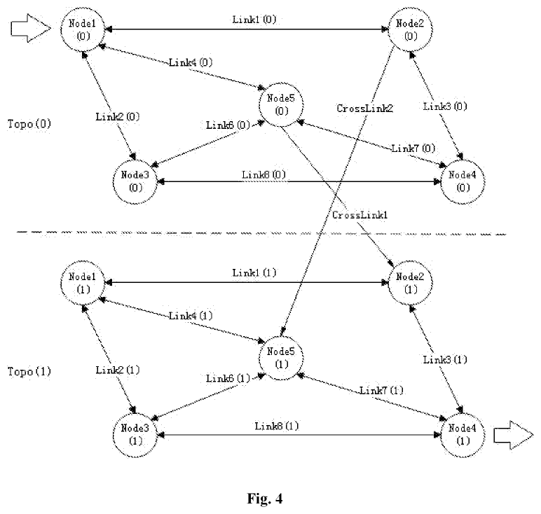

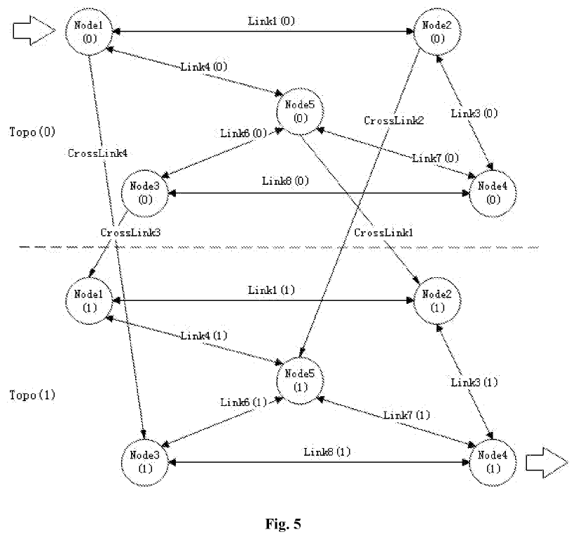

For example, as shown in FIG. 4, if the passing constraint condition indicates that Link5 is required to be passed, a copy, recorded as Topo(1), of the original network topology layer is made, and all nodes and links in the Topo(1) have the layer attribute “1”.

Node5(0) is connected with Node2(1) through a one-way link CrossLink1, and cost of the one-way link is cost of a link in a direction from Node5 to Node2 of Link5. Node2(0) is connected with Node5(1) through a one-way link CrossLink2, and cost of the one-way link is cost of a link in a direction from Node2 to Node5 of Link5. Link5(0) and Link5(1) are deleted. In such a manner, a modified network topology can be obtained.

Subsequently, in S104, K-optimal path calculation is performed by taking Node1(0) as a head node and taking Node4(1) as an end node to obtain all K-optimal paths required to pass Link5.

Finally, in S105, node IDs with the layer attribute “1” in a path calculation result are restored to obtain a final path.

In an exemplary implementation of the embodiment, when the n passing constraint condition or conditions indicate that any one link in multiple links is required to be passed, n is equal to 1, and one network topology layer is correspondingly copied. The operation S103 may be implemented in the following manner. That is, the connection of the link of each network topology layer is modified according to the n passing constraint condition or conditions and the connection of the one-way link is established between the two network topology layers with the adjacent layer attribute information may be implemented in the following manner. Connection of a one-way link between a first node of each link required to be passed in the original network topology layer and a second node of the link required to be passed in the copied network topology layer is established, and cost of the one-way link is set to be cost of a link in a direction from the first node to the second node in the same network topology layer. Connection of a one-way link between a second node of each link required to be passed in the original network topology layer and a first node of the link required to be passed in the copied network topology layer is established, and cost of the one-way link is set to be cost of a link in a direction from the second node to the first node in the same network topology layer. Each link required to be passed in the original network topology layer and each link required to be passed in the copied network topology layer are deleted.

For example, as shown in FIG. 5, if the passing constraint condition indicates that Link2 or Link5 is required to be passed, a copy, recorded as Topo(1), of the network topology layer is made, and all nodes and links in the Topo(1) have the layer attribute “1”.

Node5(0) is connected with Node2(1) through a one-way link CrossLink1, and cost of the one-way link is cost of a link in a direction from Node5 to Node2 of Link5. Node2(0) is connected with Node5(1) through a one-way link CrossLink2, and cost of the one-way link is cost of a link in a direction from Node2 to Node5 of Link5. Link5(0) and Link5(1) are deleted.

Node3(0) is connected with Node1(1) through a one-way link CrossLink3, and cost of the one-way link is cost of a link in a direction from Node3 to Node1 of Link2. Node1(0) is connected with Node3(1) through a one-way link CrossLink4, and cost of the one-way link is cost of a link in a direction from Node1 to Node3 of Link2. Link2(0) and Link2(1) are deleted.

Subsequently, in S104, K-optimal path calculation is performed by taking Node1(0) as a head node and taking Node4(1) as an end node to obtain all K-optimal paths required to pass Link2 or Link5.

Finally, in S105, node IDs with the layer attribute “1” in a path calculation result are restored to obtain a final path.

In an exemplary implementation of the embodiment, when the n passing constraint condition or conditions indicate that one or more nodes are required to be passed and one or more links are required to be passed, n is equal to a sum of the number of the one or more nodes required to be passed and the number of the one or more links required to be passed. The operation S103 may be implemented in the following manner. That is, the operation that the connection of the link of each network topology layer is modified according to the n passing constraint condition or conditions and the connection of the one-way link is established between the two network topology layers with the adjacent layer attribute information may be implemented in the following manner. Connection of one-way links are established between the adjacent network topology layers according to the one or more nodes required to be passed respectively, wherein connection of one one-way link is correspondingly established between each group of adjacent network topology layers for each node required to be passed. Connection of corresponding one-way links are established between the adjacent network topology layers according to the one or more links required to be passed respectively, wherein two one-way links are correspondingly established between each group of adjacent network topology layers for each link required to be passed. The one or more links required to be passed in the original network topology layer and the one or more links required to be passed in each copied network topology layer are deleted.

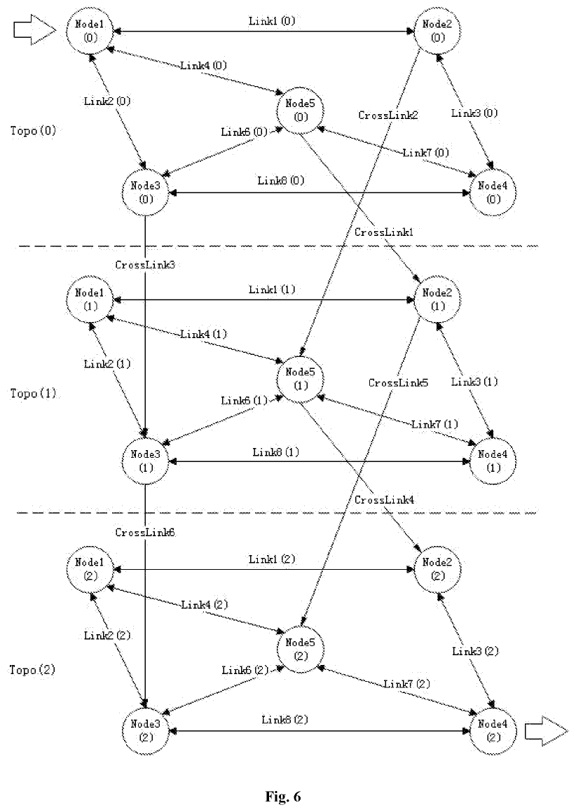

For example, as shown in FIG. 6, if the passing constraint condition indicates that Node3 is required to be passed and Link5 is required to be passed, two copies, recorded as Topo(1) and Topo(2) respectively, of the original network topology layer are made, and all nodes and links in the Topo(1) and Topo(2) have the layer attributes “1” and “2”.

Node5(0) is connected with Node2(1) through a one-way link CrossLink1, and cost of the one-way link is cost of a link in a direction from Node5 to Node2 of Link5. Node2(0) is connected with Node5(1) through a one-way link CrossLink2, and cost of the one-way link is cost of a link in a direction from Node2 to Node5 of Link5. Link5(0) and Link5(1) are deleted.

Node3(0) is connected with Node3(1) through a one-way link CrossLink3, and cost of the one-way link is set to be 0.

Node5(1) is connected with Node2(2) through a one-way link CrossLink4, and cost of the one-way link is cost of a link in a direction from Node5 to Node2 of Link5. Node2(1) is connected with Node5(2) through a one-way link CrossLink5, and cost of the one-way link is cost of a link in a direction from Node2 to Node5 of Link5. Link5(2) is deleted.

Node3(1) is connected with Node3(2) through a one-way link CrossLink6, and cost of the one-way link is set to be 0.

Subsequently, in S104, K-optimal path calculation is performed by taking Node1(0) as a head node and taking Node4(2) as an end node to obtain all K-optimal paths required to pass Node3 and Link5.

Finally, in S105, node IDs with the layer attribute “1” or “2” in a path calculation result are restored to obtain a final path.

In S104, a k-optimal path from a starting point of the head network topology layer to an ending point of the end network topology layer is calculated by use of a k-optimal path algorithm.

In the embodiment, the k-optimal path algorithm adopts a K-Shortest Paths (KSP) algorithm. The head network topology layer refers to the network topology layer Topo(0), and the end network topology layer refers to the network topology layer Topo(n).

In S105, restoration processing is performed on the layer attribute information of at least one node in the k-optimal path to obtain a final path.

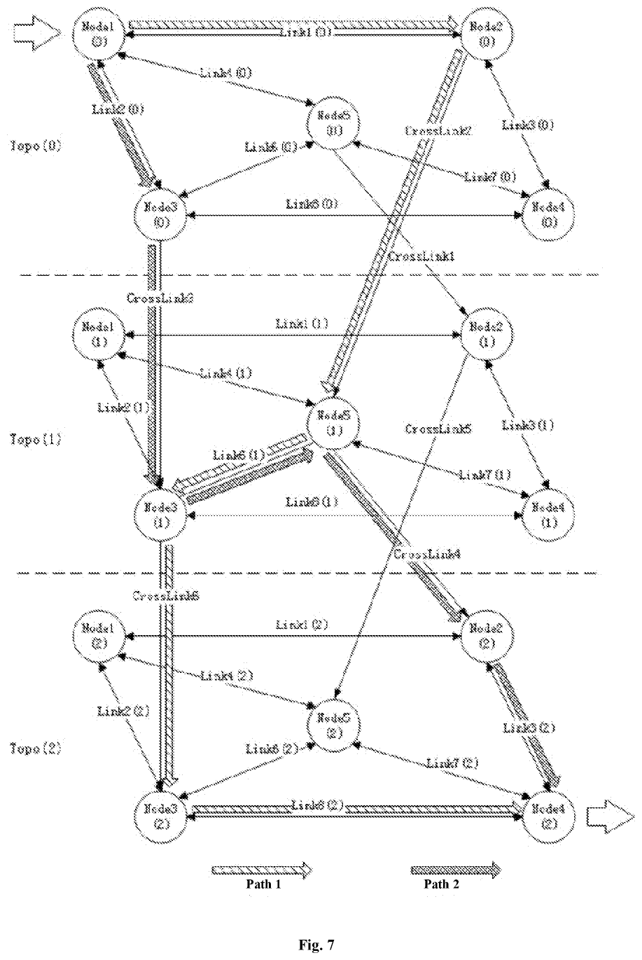

The operation that restoration processing is performed on the layer attribute information of the node in the k-optimal path may be implemented in the following manner. The layer attribute information of each node ID in the k-optimal path is restored to obtain a final k-optimal path. For example, as shown in FIG. 6, if the passing constraint conditions indicate that Node3 is required to be passed and Link5 is required to be passed, two paths in a path calculation result are shown in FIG. 7. The first path passes Node1(0)→Node2(0)→Node5(1)→Node3(1)→Node3(2)→Node4(2), and a path obtained by the restoration processing is Node1→Node2→Node5→Node3→Node4. The second path passes Node1(0)→Node3(0)→Node3(1)→Node5(1)→Node2(2)→Node4(2), and a path obtained by the restoration processing is Node1→Node3→Node5→Node2→Node4.

It can be seen from the above that, according to the routing path calculation method provided in the embodiment, first, the original network topology layer is copied according to the passing constraint condition or conditions and different layer attributes are configured for the network topology layers; then, the connection of the link of each network topology layer is modified according to the passing constraint condition or conditions, and at least one corresponding one-way link is added between different network topology layers; and finally, the k-optimal path of the modified network topology is calculated by use of the k-optimal path algorithm, and restoration processing is performed on the layer attribute of at least one node in the k-optimal path to convert the node into a node in the original network topology layer to obtain the final path. Therefore, optimal k-optimal path calculation under the condition of no sequence between passing constraints can be implemented, and no special processing is required for non-directional links required to be passed, so that the complexity of the algorithm is reduced. Moreover, path calculation under a constrained type that only one of multiple constraints is required to be met can be implemented.

### Embodiment 2

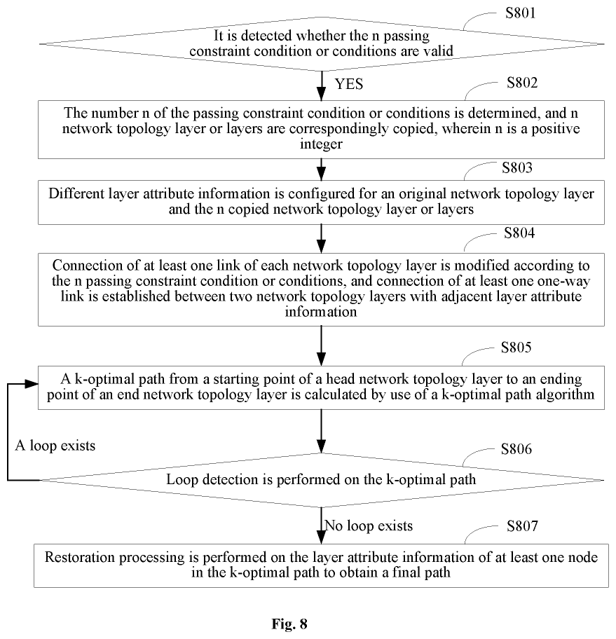

FIG. 8 is an implementation flowchart of a routing path calculation method according to embodiment 2 of the present disclosure. An execution subject of the method is a routing path calculation system/device in the embodiments of the present disclosure. As shown in FIG. 8, the routing path calculation method provided in the embodiment may include the following operations.

In S801, it is detected whether the passing constraint condition or conditions are valid or not, and in a case where the passing constraint condition or conditions are valid, proceed to S802.

The operation of detecting whether the passing constraint condition or conditions are valid or not may be implemented in the following manner. It is detected whether an original network topology layer for routing includes the node or nodes required to be passed and/or the link or links required to be passed in the passing constraint condition or conditions or not. In a case where the original network topology layer for routing includes the node or nodes required to be passed and/or the link or links required to be passed in the passing constraint condition or conditions, it is determined that the passing constraint condition or conditions are valid. In a case where the original network topology layer for routing does not include the node or nodes required to be passed and/or the link or links required to be passed in the passing constraint condition or conditions, it is determined that the passing constraint condition or conditions are invalid.

Optionally, in the embodiment, when it is detected that the passing constraint condition or conditions are invalid, a prompt is made to a user such that the user resets the passing constraint condition or conditions.

In S802, the number n of passing constraint condition or conditions is determined, and n network topology layer or layers are correspondingly copied, wherein n is a positive integer.

In S803, different layer attribute information is configured for an original network topology layer and the n copied network topology layer or layers.

In S804, connection of at least one link of each network topology layer is modified according to the n passing constraint condition or conditions, and connection of at least one one-way link is established between two network topology layers with adjacent layer attribute information.

In S805, a k-optimal path from a starting point of the head network topology layer to an ending point of the end network topology layer is calculated by use of a k-optimal path algorithm.

In S806, loop detection is performed on the k-optimal path; in a case where the k-optimal path includes a loop, S805 is re-executed to recalculate the k-optimal path; and in a case where the k-optimal path includes no loop, S807 is entered.

The operation that loop detection is performed on the k-optimal path specifically may be implemented in the following manner. It is judged whether the k-optimal path passes the same nodes in different layers or not. In a case where the k-optimal path passes the same nodes in the different layers, it is judged whether the same nodes in the different layers are adjacent in the k-optimal path or not. If the same nodes in the different layers are not adjacent, the k-optimal path is considered to include the loop; and if the same nodes in the different layers are adjacent or the k-optimal path does not pass the same nodes in the different layers, it is determined that the k-optimal path includes no loop.

In S807, restoration processing is performed on the layer attribute information of at least one node in the k-optimal path to obtain a final path.

It is to be noted that S802 to S805 and S807 in the embodiment are completely the same as S101 to S105 in the above embodiment respectively and thus will not be elaborated herein.

It can be seen from the above that, compared with the above embodiment, the embodiment has the advantages that the validation of the passing constraint condition or conditions is required to be detected at first before the number n of the passing constraint condition or conditions is determined and the subsequent flow is entered when the passing constraint condition or all the passing constraint conditions are valid, so that smooth path calculation may be ensured. Before restoration processing is performed on the layer attribute of the node in the k-optimal path, loop detection is performed on the k-optimal path, the k-optimal path is recalculated when the loop is detected. When it is confirmed that there is no loop, restoration processing is performed on the layer attribute of the node in the k-optimal path to obtain the final path, so that the reliability of the final path may be ensured.

### Embodiment 3

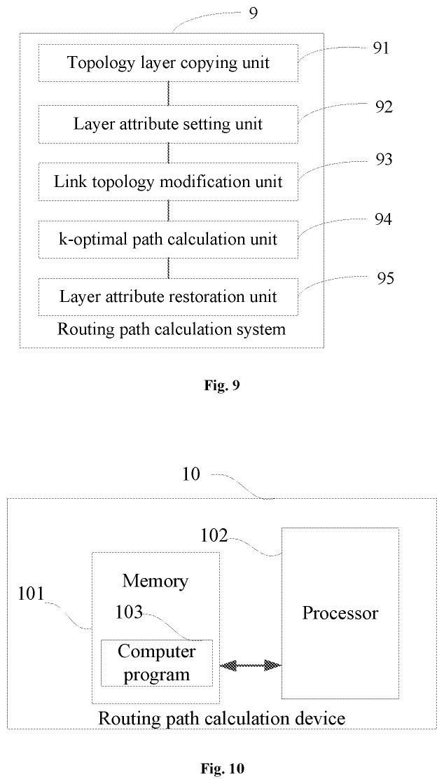

FIG. 9 is a structure diagram of a routing path calculation system according to embodiment 3 of the present disclosure. For convenient description, only parts related to the embodiment are shown.

As shown in FIG. 9, the routing path calculation system 9 provided in the embodiment includes: a topology layer copying unit 91, configured to determine the number n of passing constraint condition or conditions and correspondingly copy n network topology layer or layers, wherein n is a positive integer; a layer attribute setting unit 92, configured to configure different layer attribute information for an original network topology layer and the n copied network topology layer or layers; a link topology modification unit 93, configured to modify connection of at least one link of each network topology layer according to the n passing constraint condition or conditions and establish connection of at least one one-way link between two network topology layers with adjacent layer attribute information; a k-optimal path calculation unit 94, configured to calculate a k-optimal path between a starting point of the head network topology layer to an ending point of the end network topology layer by use of a k-optimal path algorithm; and a layer attribute restoration unit 95, configured to perform restoration processing on the layer attribute information of at least one node in the k-optimal path to obtain a final path.

It is to be noted that, since each unit in the system provided in the embodiment of the present disclosure is based on the same concept as the method embodiment of the present disclosure, the technical effects achieved by the units are the same as those in the method embodiment of the present disclosure. Specific contents may refer to the descriptions in the method embodiment of the present disclosure and will not be elaborated herein.

It can be understood by those of ordinary skill in the art that all or some operations in the method disclosed in the embodiments may be implemented into software, firmware, hardware and proper combinations thereof.

### Embodiment 4

FIG. 10 is a structure diagram of a routing path calculation device according to embodiment 4 of the present disclosure. For convenient description, only parts related to the embodiment are shown.

As shown in FIG. 10, the routing path calculation device 10 provided in the embodiment of the present disclosure includes a memory 101, a processor 102 and a computer program 103 stored in the memory 102 and capable of running in the processor. The computer program 103 is executed by the processor 102 to implement the operations of the routing path calculation method of embodiment 1 or embodiment 2. Most typically, the device is a router.

The device of the embodiment of the present disclosure belongs to the same concept as the routing path calculation method of embodiment 1 or embodiment 2, and details about a specific implementation process thereof refer to the method embodiment. Technical features in the method embodiment are correspondingly applied to the device embodiment and will not be elaborated herein.

It can be understood by those of ordinary skill in the art that all or some operations in the method disclosed in the embodiments may be implemented into software, firmware, hardware and proper combinations thereof.

### Embodiment 5

Embodiment 5 of the present disclosure provides a computer-readable storage medium, in which a computer program is stored. The computer program is executed by a processor to execute the operations of the routing path calculation method of embodiment 1 or embodiment 2.

The computer-readable storage medium of the embodiment of the present disclosure belongs to the same concept as the routing path calculation method of embodiment 1 or embodiment 2, and details about a specific implementation process thereof refer to the corresponding method embodiment. Technical features in the method embodiment are correspondingly applied to the embodiment and will not be elaborated herein.

It can be understood by those of ordinary skill in the art that all or some operations in the method disclosed in the embodiments may be implemented into software, firmware, hardware and proper combinations thereof.

In a hardware implementation mode, division of the functional modules/units mentioned in the above descriptions does not always correspond to division of physical components. For example, a physical component may have multiple functions, or a function or operation may be cooperatively executed by a plurality of physical components. Some physical components or all physical components may be implemented into software executed by a processor such as a central processing unit, a digital signal processor or a microprocessor, or implemented into hardware, or implemented into integrated circuits such as application specific integrated circuits. Such software may be distributed in a computer-readable medium, and the computer-readable medium may include a computer storage medium (or a non-transitory medium) and a communication medium (or a temporary medium). As known to those of ordinary skill in the art, term computer storage medium includes volatile, nonvolatile, removable and irremovable media implemented in any method or technology for storing information (for example, computer-readable instructions, data structures, program modules or other data). The computer storage medium includes, but not limited to, a Random Access Memory (RAM), a Read-Only Memory (ROM), an Electrically Erasable Programmable ROM (EEPROM), a flash memory or another memory technology, a Compact Disc Read-Only Memory (CD-ROM), a Digital Video Disk (DVD) or another optical disk, a cassette, a magnetic tape, a disk memory or another magnetic storage device, or any other medium that may be configured to store expected information and may be accessed by a computer. In addition, it is known to those of ordinary skill in the art that a communication medium usually includes a computer-readable instruction, a data structure, a program module or other data in modulated data signals of, for example, a carrier or another transmission mechanism, and may include any information delivery medium.

The preferred embodiments of the present disclosure are described above with reference to the drawings and not thus intended to limit the scope of protection of the present disclosure. Any modifications, equivalent replacements and improvements made by those skilled in the art without departing from the scope and essence of the present disclosure shall fall within the scope of protection of the present disclosure.

1. A routing path calculation method performed by a routing path calculation system or device, comprising:
determining the number n of passing constraint condition or conditions, and correspondingly copying n network topology layer or layers, wherein n is a positive integer;
configuring different layer attribute information for an original network topology layer and the n copied network topology layer or layers;
modifying connection of at least one link of each network topology layer according to the n passing constraint condition or conditions, and establishing connection of at least one one-way link between two network topology layers with adjacent layer attribute information;
calculating a k-optimal path from a starting point of a head network topology layer to an ending point of an end network topology layer by use of a k-optimal path algorithm; and
performing restoration processing on the layer attribute information of at least one node in the k-optimal path to obtain a final path.

2. The routing path calculation method according to claim 1, wherein when the n passing constraint condition or conditions indicate that one node is required to be passed, n is equal to 1, and one network topology layer is correspondingly copied; and
modifying the connection of the link of each network topology layer according to the n passing constraint condition or conditions and establishing the connection of the one-way link between the two network topology layers with the adjacent layer attribute information comprises:
establishing the connection of a one-way link between the node required to be passed in the original network topology layer and the node required to be passed in the copied network topology layer, and setting cost of the one-way link to be 0.

3. The routing path calculation method according to claim 1, wherein when the n passing constraint condition or conditions indicate that one link is required to be passed, n is equal to 1, and one network topology layer is correspondingly copied;
modifying the connection of the link of each network topology layer according to the n passing constraint condition or conditions and establishing the connection of the one-way link between the two network topology layers with the adjacent layer attribute information comprises:
establishing connection of a one-way link between a first node of the link required to be passed in the original network topology layer and a second node of the link required to be passed in the copied network topology layer, and setting cost of the one-way link to be cost of a link in a direction from the first node to the second node in the same network topology layer;
establishing connection of a one-way link between a second node of the link required to be passed in the original network topology layer and a first node of the link required to be passed in the copied network topology layer, and setting cost of the one-way link to be cost of a link in a direction from the second node to the first node in the same network topology layer; and
deleting the link required to be passed in the original network topology layer and the link required to be passed in the copied network topology layer.

4. The routing path calculation method according to claim 1, wherein when the n passing constraint condition or conditions indicate that any one link in multiple links is required to be passed, n is equal to 1, and one network topology layer is correspondingly copied;
modifying the connection of the link of each network topology layer according to the n passing constraint condition or conditions and establishing the connection of the one-way link between the two network topology layers with the adjacent layer attribute information comprises:
establishing connection of a one-way link between a first node of each link required to be passed in the original network topology layer and a second node of the link required to be passed in the copied network topology layer, and setting cost of the one-way link to be cost of a link in a direction from the first node to the second node in the same network topology layer;
establishing connection of a one-way link between a second node of each link required to be passed in the original network topology layer and a first node of the link required to be passed in the copied network topology layer, and setting cost of the one-way link to be cost of a link in a direction from the second node to the first node in the same network topology layer; and
deleting each link required to be passed in the original network topology layer and each link required to be passed in the copied network topology layer.

5. The routing path calculation method according to claim 1, wherein when the n passing constraint condition or conditions indicate that one or more nodes are required to be passed and one or more links are required to be passed, n is the sum of the number of the one or more nodes required to be passed and the number of the one or more links required to be passed;
modifying the connection of the link of each network topology layer according to the n passing constraint condition or conditions and establishing the connection of the one-way link between the two network topology layers with the adjacent layer attribute information comprises:
establishing connection of one-way links between the adjacent network topology layers according to the one or more nodes required to be passed respectively, wherein connection of one one-way link is correspondingly established between each group of adjacent network topology layers for each node required to be passed;
establishing connection of corresponding one-way links between the adjacent network topology layers according to the one or more links required to be passed respectively, wherein two one-way links are correspondingly established between each group of adjacent network topology layers for each link required to be passed; and
deleting the one or more links required to be passed in the original network topology layer and the one or more links required to be passed in each copied network topology layer.

6. The routing path calculation method according to claim 1, after calculating the k-optimal path from the starting point of the head network topology layer to the ending point of the end network topology layer by use of the k-optimal path algorithm, further comprising:
performing loop detection on the k-optimal path;
in a case where the k-optimal path comprises a loop, recalculating the k-optimal path; and
in a case where the k-optimal path does not comprise any loop, executing the operation of performing the restoration processing on the layer attribute information of the at least one node in the k-optimal path to obtain the final path.

7. The routing path calculation method according to claim 1, before determining the number n of the passing constraint condition or conditions and correspondingly copying the n network topology layer or layers, further comprising:
detecting whether the passing constraint condition or conditions are valid or not; and
in a case where the passing constraint condition or conditions are valid, entering the operation of determining the number n of the passing constraint condition or conditions.

8. A routing path calculation device, comprising a memory storing instructions and a processor in communication with the memory, wherein the processor is configured to execute the instructions to:
determine the number n of passing constraint condition or conditions and correspondingly copy n network topology layer or layers, wherein n is a positive integer;
configure different layer attribute information for an original network topology layer and the n copied network topology layer or layers;
modify connection of at least one link of each network topology layer according to the n passing constraint condition or conditions and establish connection of at least one one-way link between two network topology layers with adjacent layer attribute information;
calculate a k-optimal path between a starting point of a head network topology layer to an ending point of an end network topology layer by use of a k-optimal path algorithm; and
perform restoration processing on the layer attribute information of at least one node in the k-optimal path to obtain a final path.

9. (canceled)

10. A non-transitory computer-readable storage medium, in which a computer program is stored, wherein the computer program is executed by a processor to:
determine the number n of passing constraint condition or conditions and correspondingly copy n network topology layer or layers, wherein n is a positive integer;
configure different layer attribute information for an original network topology layer and the n copied network topology layer or layers;
modify connection of at least one link of each network topology layer according to the n passing constraint condition or conditions and establish connection of at least one one-way link between two network topology layers with adjacent layer attribute information;
calculate a k-optimal path between a starting point of a head network topology layer to an ending point of an end network topology layer by use of a k-optimal path algorithm; and
perform restoration processing on the layer attribute information of at least one node in the k-optimal path to obtain a final path.

11. The routing path calculation method according to claim 1, wherein correspondingly copying the n network topology layer or layers comprises:
correspondingly copying the n network topology layer or layers according to the original network topology layer of a routing device.

12. The routing path calculation method according to claim 1, wherein configuring different layer attribute information for the original network topology layer and the n copied network topology layer or layers comprises:
assigning different layer numbers to the original network topology layer and the n copied network topology layer or layers.

13. The routing path calculation method according to claim 12, wherein the head network topology layer refers to the network topology layer with the smallest layer number while the end network topology layer refers to the network topology layer with the largest layer number.

14. The routing path calculation method according to claim 12, wherein configuring different layer attribute information for the original network topology layer and the n copied network topology layer or layers further comprises:
marking the assigned layer number after Identifier (ID) of each node and each link in each network topology layer to represent that the node and the link belong to the network topology layer assigned with the layer number.

15. The routing path calculation method according to claim 7, wherein detecting whether the passing constraint condition or conditions are valid or not comprises:
detecting whether the original network topology layer comprises a node or nodes required to be passed and/or a link or links required to be passed in the passing constraint condition or conditions or not;
in a case where the original network topology layer comprises the node or nodes required to be passed and/or the link or links required to be passed in the passing constraint condition or conditions, determining that the passing constraint condition or conditions are valid;
in a case where the original network topology layer does not comprise the node or nodes required to be passed and/or the link or links required to be passed in the passing constraint condition or conditions, determining that the passing constraint condition or conditions are invalid.

16. The routing path calculation method according to claim 6, wherein performing the loop detection on the k-optimal path comprises:
judging whether the k-optimal path passes the same nodes in different network topology layers or not;
in a case where the k-optimal path passes the same nodes in the different network topology layers, judging whether the same nodes in the different network topology layers are adjacent in the k-optimal path or not;
in a case where the same nodes in the different network topology layers are not adjacent, determining that the k-optimal path comprises the loop; and
in a case where the same nodes in the different network topology layers are adjacent or the k-optimal path does not pass the same nodes in the different network topology layers, determining that the k-optimal path does not comprise any loop.

17. The routing path calculation device according to claim 8, wherein when the n passing constraint condition or conditions indicate that one node is required to be passed, n is equal to 1, and one network topology layer is correspondingly copied; and
the processor, when configured to modify the connection of the link of each network topology layer according to the n passing constraint condition or conditions and establishing the connection of the one-way link between the two network topology layers with the adjacent layer attribute information, is configured to:
establish the connection of a one-way link between the node required to be passed in the original network topology layer and the node required to be passed in the copied network topology layer, and set cost of the one-way link to be 0.

18. The routing path calculation device according to claim 8, wherein wherein when the n passing constraint condition or conditions indicate that one link is required to be passed, n is equal to 1, and one network topology layer is correspondingly copied;
the processor, when configured to modify the connection of the link of each network topology layer according to the n passing constraint condition or conditions and establishing the connection of the one-way link between the two network topology layers with the adjacent layer attribute information, is configured to:
establish connection of a one-way link between a first node of the link required to be passed in the original network topology layer and a second node of the link required to be passed in the copied network topology layer, and set cost of the one-way link to be cost of a link in a direction from the first node to the second node in the same network topology layer;
establish connection of a one-way link between a second node of the link required to be passed in the original network topology layer and a first node of the link required to be passed in the copied network topology layer, and set cost of the one-way link to be cost of a link in a direction from the second node to the first node in the same network topology layer; and
delete the link required to be passed in the original network topology layer and the link required to be passed in the copied network topology layer.

19. The routing path calculation device according to claim 8, wherein when the n passing constraint condition or conditions indicate that any one link in multiple links is required to be passed, n is equal to 1, and one network topology layer is correspondingly copied;
the processor, when configured to modify the connection of the link of each network topology layer according to the n passing constraint condition or conditions and establishing the connection of the one-way link between the two network topology layers with the adjacent layer attribute information, is configured to:
establish connection of a one-way link between a first node of each link required to be passed in the original network topology layer and a second node of the link required to be passed in the copied network topology layer, and set cost of the one-way link to be cost of a link in a direction from the first node to the second node in the same network topology layer;
establish connection of a one-way link between a second node of each link required to be passed in the original network topology layer and a first node of the link required to be passed in the copied network topology layer, and set cost of the one-way link to be cost of a link in a direction from the second node to the first node in the same network topology layer; and
delete each link required to be passed in the original network topology layer and each link required to be passed in the copied network topology layer.

20. The routing path calculation device according to claim 8, wherein when the n passing constraint condition or conditions indicate that one or more nodes are required to be passed and one or more links are required to be passed, n is the sum of the number of the one or more nodes required to be passed and the number of the one or more links required to be passed;
the processor, when configured to modify the connection of the link of each network topology layer according to the n passing constraint condition or conditions and establishing the connection of the one-way link between the two network topology layers with the adjacent layer attribute information, is configured to:
establish connection of one-way links between the adjacent network topology layers according to the one or more nodes required to be passed respectively, wherein connection of one one-way link is correspondingly established between each group of adjacent network topology layers for each node required to be passed;
establish connection of corresponding one-way links between the adjacent network topology layers according to the one or more links required to be passed respectively, wherein two one-way links are correspondingly established between each group of adjacent network topology layers for each link required to be passed; and
delete the one or more links required to be passed in the original network topology layer and the one or more links required to be passed in each copied network topology layer.

21. The routing path calculation device according to claim 8, wherein the processor is further configured to execute the instructions to, after calculating the k-optimal path from the starting point of the head network topology layer to the ending point of the end network topology layer by use of the k-optimal path algorithm:
perform loop detection on the k-optimal path;
in a case where the k-optimal path comprises a loop, recalculate the k-optimal path; and
in a case where the k-optimal path does not comprise any loop, execute the operation of performing the restoration processing on the layer attribute information of the at least one node in the k-optimal path to obtain the final path.
